(19) United States
(12) Patent Application Publication
(10) Pub. No.: US 2004/0265603 A1
(43) Pub. Date: Dec. 30, 2004

(54) Composite polyelectrolyte films for corrosion control

(76) Inventor: Joseph B Schlenoff, Tallahassee, FL (US)

Correspondence Address: SENNIGER POWERS LEAVITT AND ROEDEL, ONE METROPOLITAN SQUARE, 16TH FLOOR, ST LOUIS, MO, 63102, US

(21) Appl. No.: 10/485,704

(22) PCT Filed: Jul. 12, 2002
(86) PCT No.: PCT/US02/22387

Related U.S. Application Data
(60) Provisional application No. 60/309,960, filed on Aug. 3, 2001.

(51) Int. Cl. B32B 15/08; B05D 1/36

(52) U.S. Cl. 428/461; 427/402; 427/421.1; 428/457

(57) ABSTRACT

A corrosion resistant structure and a method for preparing the same. The corrosion resistant structure comprises a metallic substrate comprising a surface and an anticorrosion polymer coating deposited onto at least a portion of the metallic substrate surface. The anticorrosion polymer coating comprises a polyelectrolyte complex which comprises a positively-charged polyelectrolyte and a negatively-charged polyelectrolyte.

### CROSS-REFERENCE TO RELATED APPLICATIONS

This application is a national stage application of International Application No. PCT/US02/22387, filed Jul. 12, 2002, which claims the benefit of U.S. Provisional Application 60/309,960, filed Aug. 3, 2001, each of which is hereby incorporated herein by reference.

### STATEMENT REGARDING FEDERALLY SPONSORED RESEARCH OR DEVELOPMENT

This invention was made with Government support under grant number DMR 9727717 awarded by the National Science Foundation. The Government has certain rights in this invention.

### BACKGROUND OF THE INVENTION

The present invention relates generally to the use of a thin film coating, comprising charged polymers, for the protection of metals and alloys against corrosion.

Many methods are applied for corrosion protection and these rely on either inorganic or organic based coatings. In these coatings, water is typically excluded. Inorganic based coatings include those prepared by chemical vapor deposition (CVD) and physical vapor deposition (PVD) where hard coatings like TiC,TiN,Si₃N₄, and FeB are deposited. Pulker, H. K. Wear and Corrosion Resistant Coatings by CVD and PVD, (Ellis Horwood Ltd., Halsted Press., N.Y., 1989). Cathodic protection by sacrificial metal coatings (Zn,Al,Mg,Cd, and their alloys) has been widely used, where electrode potentials of sacrificial coatings are more negative than those of iron and steel. See Pulker, H. K.; Sedriks A. J. Corrosion of Stainless Steels, Corrosion Monograph Series, (Wiley, New York, 1996); and Böhni, H. in Uhlig's Corrosion Handbook (ed. Revie, R. W.) (Wiley, New York, 2000). Anodic control protection by noble metals coatings (Ni,Cr,Sn,Cu,Ag,Au, and their alloys) are usually applied when a decorative appearance is required. These coatings are characterized by a passivated surface, which is thus inert to environmental degradation. Inorganic coatings are relatively expensive to apply and after long exposure cracks can develop in the coatings leading to the formation of corrosion cells.

For the past 25 years, the U.S. Department of Transportation has required all new underground metallic piping—which is typically steel—conveying petroleum and natural gas to be cathodically protected as a secure measure to reduce the risk of catastrophic corrosion-related failure. Cathodic protection does not work well on extensively corroded metal surfaces, where current leakages are high near the joints. See Yalden, R. F. In Situ Cathodic Protection of Ductile Iron Pipeline, Proceedings of the 11^{th} International Conference on Pipeline Protection (Florence, Italy, Oct. 9-11, 1995), Published by Mechanical Engineering Publications Ltd., Suffolk, UK, 1995, p197. The main drawbacks to using cathodic protection are the additional capital cost and the need for continual monitoring. One estimate puts the operating costs of a cathodic protection system to be 370 times as much as the polyethylene encasement and 6 times the initial purchasing cost of a typical ductile iron pipe. See Craft, G. Corrosion Protection-A Cost Comparison, U.S. Piper, 65, (2), Fall-Winter, 1995-1996, p14; and Noonan, J. R.; Bradish, B. M. New Bonded Tape Coating Systems and Cathodic protection Applied to Non-steel Water Pipelines: Quality Through Proper Design Specifications, Proceedings of the 2^{nd} International Conference on Underground Pipeline Engineering, Bellevue, Wash., 1995, p765.

Organic coatings are very effective in corrosion control and are divided into paints and polymer coatings. Paint coatings are composed of the “vehicle” (a mixture of resin, oil, and solvents), the pigment (a mixture of metal powders, inorganic salts (such as TiO₂), and additives (dryer, hardner, and plasticizer). The vehicle is usually an organic solvent, which has some toxicity. Paints which have low volatile organic carbon (VOC) are advantageous from an environmental standpoint. Paints break down by thermal reactions, oxidation, photo-oxidation, photo-thermal reactions, and mechanical failure (rupturing, wrinkling, cracking, and peeling). The glass transition temperature, T_{g}, is an important factor in controlling the physical properties of paint films. Movement of the “vehicle” molecules becomes more active when the temperature of the environment is greater than T_{g} of the paint, thus enhancing the permeability to water and oxygen. “Blistering” is another factor that causes more than 70% of all paint coating failures. Permeation of moisture into paint/substrate interface causes the formation of blisters. A blister starts with micro entrapment of water that causes the formation of corrosion cells and, thereby, rust is formed at the solid paint interface. Paints also suffer from cathodic delamination where the formation of alkaline solution at the cathodic sites breaks the constituents of the paint. See Suzuki, I. Corrosion-resistant Coatings Technology, Marcel Dekker, Inc., N.Y., Basel; and Leidheiser, H. Corrosion-NACE, 1982, 36, 374.

Typical corrosion resistant paints are oils and the phenolic, phthalic acid, melamine, vinyl, epoxy, polyurethane, and acrylic resins. Combination sprayed zinc/sprayed bitumastic paint coatings are the most commonly used coatings for protection of the exterior of ductile iron pipes in Europe. This coating also has limited use in Asia and North America. In this method, a flash of zinc spray is applied before the bituminous paint to impart a notional degree of sacrificial protection. During the early 1980's the thickness of the zinc spray coating was increased adding to the production costs. Various experimental studies have indicated that the thin (about 50-70 micrometers) sprayed zincibitumastic coating method offers at best only a marginal enhancement of short-term corrosion protection for steel surfaces. Corrosion pitting is found to be the major culprit in all the failure cases of these coatings.

The films that are the subject of this invention belong to the family of polymer coatings. Polymeric material is typically used for barrier applications such as linings for vessels and columns. See Sedriks A. J.; Böhni, H.; and Khaladkar, P. R. in Uhlig's Corrosion Handbook (ed. Revie, R. H.) 965-1022 (Wiley, New York, 2000). Thin linings (<635 mm) include the spray applied epoxy, phenolic, or neoprene coatings, the spray and baked fluoropolymer [i.e., polytetrafluoroethylene (PTFE), fluorinated ethylene propylene (PFA)] coatings, and the flame spray polyethylene copolymer coatings. Thick linings (>635 mm) include the trowel applied reinforced vinyl ester or epoxy coatings, the sheet elastomeric chlorobutyl rubber, and the cured neoprene coatings. Also, a whole family exists of fluoropolymers and thermoplastics [i.e., polyvinyl chloride (PVC), polypropylene (PP)] coatings. See Böhni, H.

The thin polymer films that are the subject of this invention are prepared using charged polymers, or polyelectrolytes, which are alternately deposited on a substrate. Specifically, a buildup of multilayers is accomplished by alternate dipping, i.e., cycling a substrate between two reservoirs containing aqueous solutions of polyelectrolytes of opposite charge, with a rinse step in pure water following each immersion. Each cycle adds a layer of polymer via electrostatic forces to the oppositely-charged surface and reverses the surface charge thereby priming the film for the addition of the next layer. Films prepared in this manner tend to be uniform, follow the contours and irregularities of the substrate and have thicknesses of about 10 to about 10,000 nm. The thickness of the films depends on many factors, including the number of layers deposited, the ionic strength of the solutions, the types of polymers, the deposition time, deposition temperature and the solvent used. Although studies have shown that the substantial interpenetration of the individual polymer layers results in little composition variation over the thickness of the film, these polymer thin films are, nevertheless, termed polyelectrolyte multilayers (“PEMUs”).

Though recently developed, PEMUs are widely used in several fields, including light emitting devices, nonlinear optics, sensors, enzyme active thin films, electrochromics, conductive coatings, patterning, analytical separations, lubricating films, biocompatibilization, dialysis, and as selective membranes for the separation of gasses and dissolved species. PEMUs are particularly suited for use as selective membranes because they are uniform, rugged, easily prepared on a variety of substrates, continuous, resistant to protein adsorption, have reproducible thicknesses, can be made very thin to allow high permeation rates and can be made from a wide range of compositions.

PEMUs have not, however, been investigated for use as coatings for controlling the corrosion of metals and alloy. This lack of interest in the use of PEMUs for anticorrosion coatings is most likely due to several factors including: their large water content (e.g., films comprising about 50% water are common), their ionic nature, though advantageous for maintaining enzyme activity, it has been considered detrimental to anticorrosion performance. Contrary to the foregoing expectations, it has been discovered that PEMUs can be used to create ultrathin films or coating that are surprisingly effective at inhibiting the corrosion of metallic surfaces when exposed to corrosive environments.

### BRIEF SUMMARY OF THE INVENTION

Among the objects and features of the present invention, therefore, is the provision of a corrosion resistant coating that is uniformly thick, the provision of a corrosion resistant coating that is easily prepared on a variety of substrates; the provision of a corrosion resistant coating that is follows the contours and irregularities of a substrate it is deposited on; the provision of a corrosion resistant coating that can be made very thin; and the provision of a corrosion resistant coating that is resistant to abrasion.

Briefly, therefore, the present invention is directed to a corrosion resistant structure comprising a metallic substrate comprising a surface and an anticorrosion polymer coating deposited onto at least a portion of the metallic substrate surface, the anticorrosion polymer coating comprising a polyelectrolyte complex, the polyelectrolyte complex comprising a positively-charged polyelectrolyte and a negatively-charged polyelectrolyte.

The present invention is directed to a method for preparing a corrosion resistant structure. The method comprises providing a metallic substrate comprising a surface and depositing onto at least a portion of the metallic substrate surface an anticorrosion polymer coating that comprises a polyelectrolyte complex. The polyelectrolyte complex comprises a positively-charged polyelectrolyte and a negatively-charged polyelectrolyte.

Other objects will be in part apparent and in part pointed out hereinafter.

### BRIEF DESCRIPTION OF THE DRAWINGS

FIG. 1 is a plot of corrosion current versus applied potential for an uncoated abraded stainless steel wire, a PDAD/PSS coated abraded stainless steel wire and a PNO4VPI/PSS coated abraded stainless steel wire.

FIG. 2 is a plot of current versus time in the metastable pitting region for an uncoated abraded stainless steel wire and a PDAD/PSS coated abraded stainless steel wire.

FIG. 3 are scanning electron micrographs of an uncoated abraded stainless steel wire and a PDAD/PSS coated abraded stainless steel wire after being exposed to a corrosive environment.

### DETAILED DESCRIPTION OF THE INVENTION

In general, the present invention is directed to the preparation of a coating comprising positively and negatively charged polymers deposited on, or adhering to, a surface of a substrate which when exposed to certain environmental conditions is subject to chemical attack (e.g., atmospheric attack, electrochemical attack, galvanic attack, and gaseous oxidation).

The materials which may be protected from by corrosion by the present invention include, e.g., iron, aluminum, magnesium, copper, titanium, beryllium, silicon, chromium, manganese, cobalt, nickel, palladium, lead, cerium, lithium, sodium, potassium, silver, cadmium, molybdenum, hafnium, antimony, tungsten, tantalum, vanadium, uranium and mixtures and alloys thereof (e.g., stainless steel). A common form of corrosion is oxidation when exposed to atmospheric oxygen. Although the oxidation of metals such as aluminum and copper is self-limiting (i.e., the oxide layer becomes thick and dense enough to prevent the further diffusion of oxygen to the metal), other metals such as lithium and silver will oxidize until consumed. Chemical attack is not limited to oxidation, for example, under certain conditions atmospheric nitrogen can react to form nitride layers. Likewise, sulfur from hydrogen sulfide and other sulfur-containing gases can corrode materials. Even hydrogen gas can permeate into a metal such as titanium and react to form brittle hydride compounds which result in a general loss of ductility.

The oppositely charged polymers (i.e., polyelectrolytes) used to form the anticorrosion coating are water and/or organic soluble, or dispersed in water and/or organic solvent, and comprise monomer units that are positively or negatively charged. Polyelectrolytes are defined as macromolecules bearing a plurality of charged units arranged in a spatially regular or irregular manner. Polyelectrolytes may be synthetic (synthetic polyelectrolytes), naturally occurring (such as proteins, enzymes, polynucleic acids), or synthetically modified naturally occurring macromolecules (such as modified celluloses and lignins). The polyelectrolytes used in the present invention may be copolymers that have a combination of charged and/or neutral monomers (e.g., positive and neutral; negative and neutral; positive and negative; or positive, negative and neutral). Copolymers are defined as macromolecules having a combination of two or more repeat units. Regardless of the exact combination of charged and neutral monomers, a polyelectrolyte of the present invention is predominantly positively-charged or predominantly-negatively charged and hereinafter is referred to as a “positively-charged polyelectrolyte” or a “negatively-charged polyelectrolyte,” respectively.

Alternatively, the polyelectrolytes can be described in terms of the average charge per repeat unit in a polymer chain. For example, a copolymer composed of 100 neutral and 300 positively-charged repeat units has an average charge of 0.75 (3 out of 4 units, on average, are positively-charged). As another example, a polymer that has 100 neutral, 100 negatively-charged and 300 positively-charged repeat units would have an average charge of 0.4 (100 negatively-charged units cancel 100 positively-charged units leaving 200 positively-charged units out of a total of 500 units). Thus, a positively-charged polyelectrolyte has an average charge per repeat unit between 0 and 1. An example of a positively-charged copolymer is PDAD-co-PAC (i.e., poly(diallyidimethylammonium chloride) and polyacrylamide copolymer)—the PDAD units have a charge of 1 and the PAC units are neutral so the average charge per repeat unit is less than 1. Similarly, a negatively-charged polyelectrolyte has an average charge per repeat unit between 0 and −1.

The molecular weight of synthetic polyelectrolyte molecules is typically about 1,000 to about 5,000,000 grams/mole, and preferably about 10,000 to about 1,000,000 grams/mole. The molecular weight of naturally occurring polyelectrolyte molecules (e.g., biomolecules), however, can reach as high as 10,000,000 grams/mole. The polyelectrolyte typically comprises about 0.01% to about 40% by weight of a polyelectrolyte solution, and preferably about 0.1% to about 10% by weight.

various molecular architectures are available for polyelectrolytes and their copolymers. Polymers may be linear, branched, comb-like, dendritic or star. A homopolymer comprises only one type of repeat unit. A random copolymer consists of a random sequence of two or more different repeat units, where one or more of these units may be charged. A block copolymer comprises two or more blocks of homopolymer joined together, where one or more of these blocks may be charged. One type of block copolymer comprises hydrophilic (water-loving) and hydrophobic (water-hating) blocks. Such a combination of hydrophilic and hydrophobic blocks is termed “amphiphilic.” Common examples of amphiphilic small molecules are the “soaps,”—surface active agents such as stearic acid which comprise a water-soluble head group and a water-insoluble tail. Amphiphilic molecules, both large and small, tend to form aggregates, or micelles, in water where the hydrophobic regions associate and the hydrophilic groups present themselves, on the outside of the aggregate, to the water. Often, these aggregates are very small (less than 1 micrometer) and because of the electrostatic repulsions between them, they form stable colloidal dispersions in water. Charges on the amphiphilic diblock copolymers associate with polyelectrolytes of opposite charge to form polyelectrolyte complexes. Examples of amphiphilic diblock copolymers and their stable dispersions in water are polystyrene-block-poly(acrylic acid) (e.g. see Zhang and Eisenberg, J. Am. Chem. Soc. 1996, 118, 3168), polystyrene-block-polyalkylpyridinium (e.g. see Gao et al. Macromolecules 1994, 27, 7923), poly(dimethylaminoethylmethacrylate-block-poly(methyl methacrylate) (e.g. see Webber et al. Langmuir 2001, 17, 5551), and sulfonated styrene-block-ethylene/butylene (e.g. see Balas et al. U.S. Pat. No. 5,239,010, Aug. 24, 1993). See Zhang and Eisenberg, J. Am. Chem. Soc. 1996, 118, 3168; Gao et al. Macromolecules 1994, 27, 7923, Webber et al. Langmuir 2001, 17, 5551; Balas et al. U.S. Pat. No. 5,239,010, Aug. 24, 1993. Such block copolymers have been prepared with the A-B diblock , or the A-B-A triblock architectures.

The charges on a polyelectrolyte may be derived directly from the monomer units or they may be introduced by chemical reactions on a precursor polymer. For example, PDAD is made by polymerizing diallyidimethylammonium chloride, a positively charged water soluble vinyl monomer. PDAD-co-PAC is made by the polymerization of diallyldimethylammonium chloride and acrylamide (a neutral monomer which remains neutral in the polymer). Poly(styrenesulfonic acid) is often made by the sulfonation of neutral polystyrene. Poly(styrenesulfonic acid) can also be made by polymerizing the negatively charged styrene sulfonate monomer. The chemical modification of precursor polymers to produce charged polymers may be incomplete and result in an average charge per repeat unit that is less than 1.0. For example, if only about 80% of the styrene repeat units of polystyrene are sulfonated, the resulting poly(stryrenesulfonic acid) has an average charge per repeat unit of about −0.8.

Examples of a negatively-charged polyelectrolyte include polyelectrolytes comprising a sulfonate group (—SO₃), such as poly(styrenesulfonic acid)(“PSS”), poly(2-acrylamido-2-methyl-1-propane sulfonic acid)(“PAMPS”), sulfonated poly(ether ether ketone)(SPEEK), sulfonated lignin, poly(ethylenesulfonic acid), poly(methacryloxyethylsulfonic acid), their salts, and copolymers thereof; polycarboxylates such as poly(acrylic acid)(“PAA”) and poly(methacrylic acid); and sulfates such as carragenin.

Examples of a positively-charged polyelectrolyte include polyelectrolytes comprising a quaternary ammonium group, such as poly(diallyidimethylammonium chloride)(“PDAD”), poly(vinylbenzyltrimethylammonium)(“PVBTA”), ionenes, poly(acryloxyethyltrimethyl ammonium chloride), poly(methacryloxy(2-hydroxy)propyltrimethyl ammonium chloride), and copolymers thereof; polyelectrolytes comprising a pyridinium group, such as, poly(N-methylvinylpyridine) (“PMVP”), other poly(N-alkylvinylpyridines), and copolymers thereof; and protonated polyamines such as poly(allylaminehydrochloride) (“PAH”) and polyethyleneimmine (“PEI”).

Many of the polymers of the present invention, such as commercial PDAD, exhibit some degree of branching. Branching can occur at random or regular intervals along the backbone of a polymer, or branching may occur from a central point, in such case the polymers are termed “star” polymers, if linear strands of polymer emanate from the central connecting point, or “dendritic” polymers if branching is initiated at the central point but branches continue to propagate going away from the central point. Branched polyelectrolytes, including star polymers, comb polymers, graft polymers, and dendritic polymers, are suitable for the purposes of this invention.

Many of the polyelectrolytes have very low toxicity. In fact, poly(diallyldimethylammonium chloride), poly(2-acrylamido-2-methyl-1-propane sulfonic acid) and their copolymers are used in the personal care industry, e.g., in shampoos. Also, because the polyelectrolytes used in the method of the present invention are synthetic or synthetically modified natural polymers, their properties (e.g., charge density, viscosity, water solubility and response to pH) may be tailored by adjusting their composition.

By definition, a polyelectrolyte solution comprises a solvent. An appropriate solvent is one in which the selected polyelectrolyte is soluble. Thus, the appropriate solvent is dependent upon whether the polyelectrolyte is considered to be hydrophobic or hydrophilic. A hydrophobic polymer displays a less favorable interaction energy with water than a hydrophilic polymer. While a hydrophilic polymer is water soluble, a hydrophobic polymer may only be sparingly soluble in water, or, more likely insoluble in water. Likewise, a hydrophobic polymer is more likely to be soluble in organic solvents than a hydrophilic polymer. In general, the higher the carbon to charge ratio of the polymer, the more hydrophobic it tends to be. For example, poly(vinyl pyridine) alkylated with a methyl group (“PNM4VP) is considered to be hydrophilic, whereas poly(vinyl pyridine) alkylated with an octyl group (“PNO4VP”) is considered to be hydrophobic. Thus, water is preferably used as the solvent for hydrophilic polyelectrolytes and organic solvents such as alcohols (e.g., ethanol) are preferably used for hydrophobic polyelectrolytes. Examples of polyelectrolytes used in accordance with this invention that are soluble in water, include poly(styrenesulfonic acid), poly(2-acrylamido-2-methyl-1-propane sulfonic acid), sulfonated lignin, poly(ethylenesulfonic acid), poly(methacryloxyethylsulfonic acid), poly(acrylic acids), poly(methacrylic acids) their salts, and copolymers thereof; as well as poly(diallyldimethylammonium chloride), poly(vinylbenzyltrimethylammonium), ionenes, poly(acryloxyethyltrimethyl ammonium chloride), poly(methacryloxy(2-hydroxy)propyltrimethyl ammonium chloride), and copolymers thereof; and polyelectrolytes comprising a pyridinium group, such as, poly(N-methylvinylpyridine), and protonated polyamines, such as poly(allylamine hydrochloride) and poly(ethyleneimmine). Examples of polyelectrolytes that are soluble in non-aqueous solvents, such as ethanol, methanol, dimethylformamide, acetonitrile, carbon tetrachloride, and methylene chloride include poly(N-alkylvinylpyridines), and copolymers thereof, where the alkyl group is longer than about 4 carbons. Other examples of polyelectrolytes soluble in organic solvents include poly(styrenesulfonic acid), poly(2-acrylamido-2-methyl-1-propane sulfonic acid), poly(diallyldimethylammonium chloride), poly(N-methylvinylpyridine) and poly(ethyleneimmine) where the small polymer counterion, for example, Na⁺, Cl⁻, H⁺, has been replaced by a large hydrophobic counterion, such as tetrabutyl ammonium or tetrathethyl ammonium or iodine or hexafluorophosphate or tetrafluoroborate or trifluoromethane sulfonate.

Some of the polyelectrolytes used in accordance with this invention only become charged at certain pH values. For example, poly(acrylic acids) and derivatives thereof are protonated (uncharged) at pH levels below about 4-6, however, at pH levels of at least about 4-6 the poly(acrylic acid) units ionize and take on a negative charge. Similarly, polyamines and derivatives thereof become charged if the pH of the solution is below about 4.

The polyelectrolyte solutions may comprise one or more “salts.” A “salt” is defined as a soluble, ionic, inorganic compound that dissociates to stable ions (e.g., sodium chloride). A salt is included in the polyelectrolyte solutions to control the thickness of the adsorbed layers. More specifically, including a salt increases the thickness of the adsorbed polyelectrolyte layer. In general increasing the salt concentration increases the thickness of the layer for a given spray coverage and contact time. This phenomenon is limited, however, by the fact that upon reaching a sufficient salt concentration multilayers tend to dissociate. Typically, the amount of salt added to the polyelectrolyte solution is about 10% by weight or less. Despite its benefits, salt is preferably excluded from the polyelectrolyte solutions because it is believed that including a salt may impair the anticorrosion benefit a polyelectrolyte coating provides. It has been discovered that the benefits of salt can be at least in part achieved by using other ions that are less corrosive, e.g., nitrate may be included as a counterion in a PDAD solution.

An anticorrosion coating of the present invention may be formed by exposing a surface to alternating oppositely charged polyelectrolyte solutions. This method, however, does not generally result in a layered morphology of the polymers within the film. Rather, the polymeric components interdiffuse and mix on a molecular level upon incorporation into the thin film (see Losche et al., Macromolecules, 1998, 31, 8893). Thus, the polymeric components form a true molecular blend, termed a “polyelectrolyte complex,” with intimate contact between polymers driven by the strong electrostatic complexation between positive and negative polymer segments. The complexed polyelectrolyte within the film has the same amorphous morphology as a polyelectrolyte complex formed by mixing aqueous solutions of positive and negative polyelectrolyte.

Alternatively, the anticorrosion coating may be applied to a surface using a pre-formed polyelectrolyte complex (see Michaels, “Polyelectrolyte complexes,” Ind. Eng. Chem. 1965, 57, 32-40). This is accomplished by mixing the oppositely-charged polyelectrolytes to form a polyelectrolyte complex precipitate which is then dissolved or resuspended in a suitable solvent/liquid to form a polyelectrolyte complex solution/dispersion. The polyelectrolyte complex solution/dispersion is then applied to the substrate surface and the solvent/liquid is evaporated, leaving behind a film comprising the polyelectrolyte complex.

Polyelectrolyte solutions and/or a polyelectrolyte complex solution, or polyelectrolyte dispersions may be deposited on the substrate by any appropriated method such as casting, dip coating, doctor blading and/or spraying. Particularly preferred are dip coating and spraying. Spraying is especially preferred when applying the coating using alternating exposure of oppositely charged polyelectrolyte solutions. Spraying alternating oppositely charged polyelectrolyte solutions has several advantages including: it allows for a more uniform film thickness, easier control of film thickness, the film is more uniform over uneven surfaces and contours, the film thickness can be made extremely thin (e.g., 10 nm), and films are readily created without the use of organic solvents which may require precautions to avoid negative health and/or environmental consequences. The solutions may be sprayed onto the substrate by any applicable means (e.g., an atomizer, an aspirator, ultrasonic vapor generator, entrainment in compressed gas). In fact, a hand operated “plant mister” has been used to spray polyelectrolyte solutions. Typically, the droplet size in the spray is about 10 nm to about 1 mm in diameter. Preferably, the droplet size is about 10 μm to 100 μm in diameter. The coverage of the spray is typically about 0.001 to 1 mL/cm², and preferably about 0.01 to 0.1 mL/cm².

On the other hand, dip coating is preferred when applying the coating using a polyelectrolyte complex solution. Dip coating has several advantages including: it allows for the formation of relatively thick films at a relatively fast rate because exposure to individual polymer solutions thereby and other organic-based anticorrosive additives may be incorporated into the polyelectrolyte complex solution. Examples of such anticorrosive additives include alkylated quarternary ammonium salts.

The duration in which a polyelectrolyte solution is typically in contact with the surface it is sprayed upon (i.e., the contact time) varies from a few seconds to several minutes to achieve a maximum, or steady-state, thickness. The contact duration is selected based on the desired relationship between throughput (i.e., the rate at which alternating layers are created) and layer thickness. Specifically, decreasing the contact duration increases throughput and decreases layer thickness whereas increasing the duration decreases throughput and increases thickness. Preferably, the contact time is selected to maximize the throughput of layers that have a satisfactory thickness and are uniform across the surface (e.g., an average thickness of about 130 nm±1.7% or 140 nm ±1.5%). Experimental results to date indicate a contact time of about 10 seconds provides a satisfactory thickness.

The oppositely-charged polyelectrolyte solutions can be sprayed immediately after each other, however, experimental results to date indicate that the films, though thicker, are of poorer quality (e.g., blobs, poor adhesion, and non-uniform film thickness). Additionally, the composition of deposited layers depends precisely on the amount of spray that impinges on the substrate and can lead to non-stoichiometric (the ratio is not controlled) complexes. Including an intermediate rinse step between the spraying of the oppositely-charged polyelectrolyte solutions, however, rinses off excess, non-bonded, polyelectrolyte and decreases, or eliminates, the formation of blobs, poor adhesion and non-uniform film thickness. Rinsing between the application of each polyelectrolyte solution also results in stoichiometric complexes. The rinsing liquid comprises an appropriate solvent (e.g., water or organic solvent such as alcohol). Preferably the solvent is water. If the solvent is inorganic (e.g., water), the rinsing liquid may also comprise an organic modifier (e.g., ethanol, methanol or propanol). The concentration of organic modifier can be as high as less than 100 percent by weight of the rinsing liquid, but is preferably less than about 50 percent by weight. The rinsing liquid may also comprise a salt (e.g., sodium chloride) which is soluble in the solvent and the organic modifier, if included in the rinsing liquid. The concentration of salt is preferably below about 10 percent by weight of the rinsing liquid. It should be noted that as the concentration of organic modifier increases the maximum solubility concentration of salt decreases. The rinsing liquid, however, should not comprise a polyelectrolyte. The rinsing step may be accomplished by any appropriate means (e.g., dipping or spraying). Although rinsing removes much of the polymer in the layer of liquid wetting the surface, the amount of waste is preferably reduced by recycling the polymer solutions removed from the surface. Optionally, prior to depositing the second through n^{th} layer of sprayed oppositely-charged polyelectrolyte solution, the surface of the multilayer structure may be dried.

Both dip coating and spraying permit a wide variety of additives to be incorporated into a film as it is formed. Additives that may be incorporated into polyelectrolyte multilayers include inorganic materials such as metallic oxide particles (e.g., silicon dioxide, aluminum oxide, titanium dioxide, iron oxide, zirconium oxide and vanadium oxide). For example, nanoparticles of zirconium oxide may be added to a polyelectrolyte solution/polyelectrolyte complex solution to improve the abrasion resistance of a deposited film. See Rosidian et al., “Ionic self-assembly of ultra hard ZrO₂/polymernanocomposite thin films”, Adv. Mater., 10, 1087-1091 (1998). Alternatively, one of the polyelectrolytes may be omitted completely and substituted by a particle, such as a colloidal oxide, bearing a surface charge. Usually the surface charge is negative and the particle therefore substitutes the negative polyelectrolyte. These particles are of diameter 1 nm-1000 nm and preferably in the range 5 nm-100 nm.

When immersed in the solvent of the polyelectrolyte solutions, such additives take on a charge which is typically negative. More precisely, when an insoluble solid is contacted with a liquid medium, an electric double layer forms at the solid-liquid interface. The electric double layer comprises an array of either positive or negative ions attached to, or adsorbed on, the surface of the solid and a diffuse layer of ions of opposite charge surrounding the charged surface of the solid and extending into the liquid medium. The electric potential across the electric double layer is known as the zeta potential. Both the magnitude and polarity of the zeta potential for a particular solid-liquid system will tend to vary depending on the composition of the solid surface and the liquid, as well as other factors, including the size of the solid and the temperature and pH of the liquid. Although the polarity of the zeta potential may vary from one particle to another within a suspension of solid particles in a liquid, the polarity of the zeta potential for the suspension as a whole is characterized by the polarity of the surface charge attached to a predominant number of solid particles within the suspension. That is, a majority of the insoluble particles in the suspension will have either a positive or negative surface charge. The magnitude and polarity of the zeta potential for a suspension of solid particles in a liquid is calculated from the electrophoretic mobilities (i.e., the rates at which solid particles travel between charged electrodes placed in the suspension) and can be readily determined using commercially available microelectrophoresis apparatus. If present, the concentration of inorganic particulate materials preferably does not exceed about 10% by weight of the solution and more preferably the concentration is between about 0.01% and about 1% by weight of the solution.

The present invention is further illustrated by the following examples which are merely for the purposes of illustration and are not to be regarded as limiting the scope of the invention or manner in which it may be practiced.

### EXAMPLE 1

Stainless steel wires (1 mm diameter), type 316L from the Fairbanks Wire Co., were abraded with emery polishing paper(4/0) from the Beher-Manning Co., rinsed with ethanol, and then washed and sonicated with deionized water for 5 minutes. Some of the abraded wires were tested uncoated and anti-corrosion coatings were deposited on some of the abraded wires by dip coating with alternating oppositely charged polyelectrolyte solutions. One particular coating was made with 10 mM poly(diallyldimethylammonium chloride) molecular weight 300,000-400,000, and poly(styrene sulfonic acid), molecular weight 70,000, aqueous polyelectrolytes in 0.25M NaCl. These were dialyzed against distilled water using 3500 MW cut-off dialysis tubing (Spectra/por). All deposition experiments were done using a robot with an 11 minute dipping time followed by a three minute rinse with pure water. See Dubas and Schlenoff, Macromolecules 1999, 32, 8153. The wires were then left to anneal in dry air for at least 24 hours. Under these conditions, the hydrophilic polyelectrolytes produced films of a thickness of about 70 nm for 20 layers. Thickness was measured with a Gaertner Scientific L116B autogain ellipsometer with 632.8 nm radiation at 70° incident angle. A refractive index of 1.55 was employed for the multilayer.

The uncoated coated wires were placed in an electrochemical cell to test the anticorrosion properties of the polyelectrolyte films. The electrochemical cell was maintained at a temperature of 22±0.5° C. The electrolyte was 0.7M NaCl (Fisher) and was degassed by high purity nitrogen. The area of the wire dipped in the electrolyte did not exceed 0.5 cm² to minimize passive background currents and to obtain random current spikes versus time. Both chronoamperometric and anodic polarization waves were recorded using an EG & G Princeton Applied Research 273 potentiostat. The reference electrode was a KCI-SCE, against which all potentials are based. Metastable pitting tests were performed at a potential of about 0.6V for about 5 to 10 minutes.

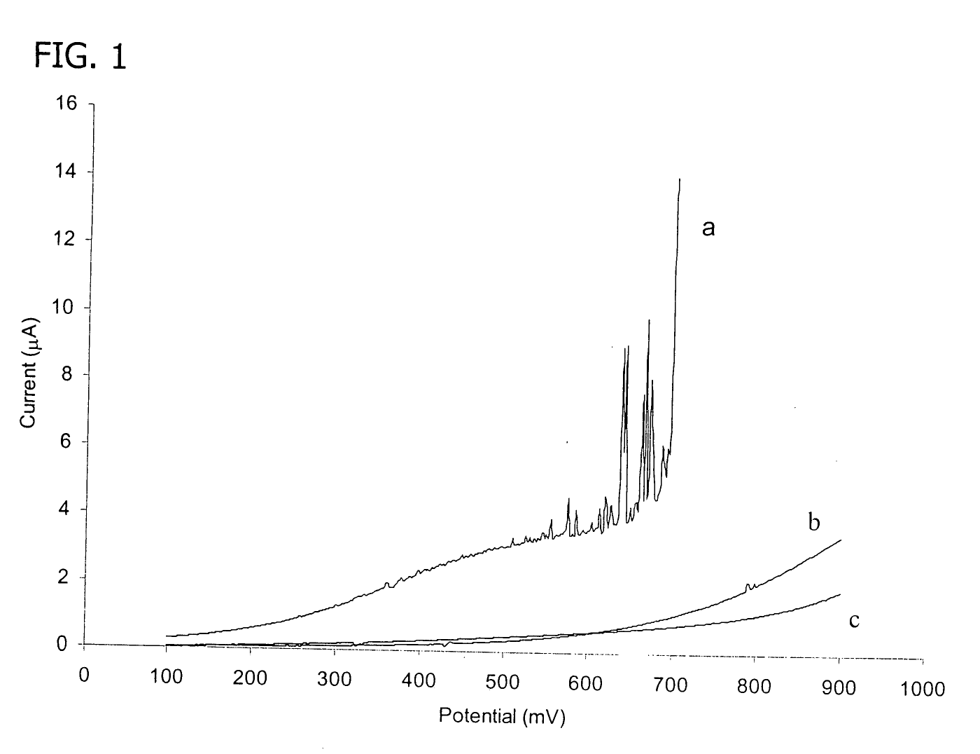

Referring to FIG. 1, the stainless steel wires showed reproducible anodic polarization curves between 0 to 0.9V vs SCE. The plot also contains random current spikes versus time at approximately 0.6V which are a characteristic of metastable pitting. The well know behavior of steel in this corrosive medium is depicted in FIG. 1—as the corrosion potential becomes increasingly more positive (more oxidizing) the corrosion current increases. In the potential region between about 0.3 and 0.7 volts, steel exhibits metastable pitting, where microscopic defects are formed by highly localized corrosion currents breaking through a thin passivating layer of surface oxide. Moments after these pits are initiated they are deactivated by the reformation of the insulating oxide layer (repassivation). Each pitting/repassivation event yields a spike on the current axis. When the potential extends beyond the metastable pitting region (greater than 0.7 volts in FIG. 1), a sustained corrosion current occurs.

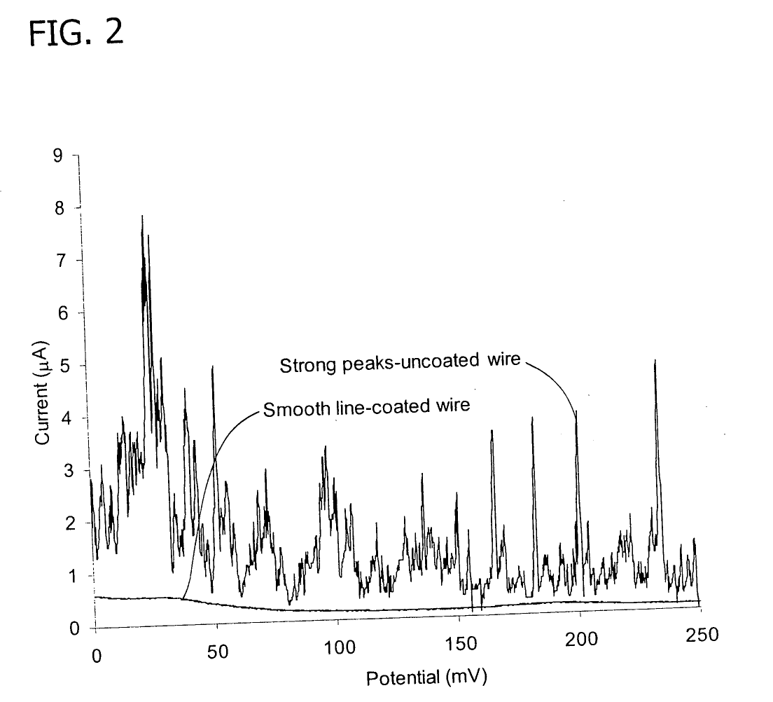

Wires coated with a PDAD/PSS multilayer exhibited a markedly contrasting behavior. As indicated in FIG. 1, the pitting is not only suppressed within the metastable pitting region, it remains suppressed at the higher currents associated with sustained corrosion. The highly effective suppression of corrosion is further illustrated in FIG. 2, which shows corrosion current vs. time for wires held at 0.6 volts (within the metastable pitting window). All pitting events for the PDAD/PSS coated wire are suppressed, whereas the uncoated wire had numerous pitting events.

It was completely unexpected that such a thin water-swollen film would provide such an effective anticorrosion coating because the presence of water typically increases the likelihood of corrosion (rusting of steel typically requires water, salt and oxygen). The polymeric constituents of polyelectrolyte multilayers are highly charged and hydrophilic, and although the individual charged units are less hydrophilic when ion paired within multilayers, each ion pair is solvated. Thus, in contact with water, the PDAD/PSS multilayer, for example, contained at least about 50 wt % water. See Dubas and Schlenoff, “Swelling and Smoothing in Polyelectrolyte Multilayers”, Langmuir 2001, 17, 7725. Despite such a high water content, the film provided remarkable corrosion resistance. Without being held to a particular theory, it is presently believed that the primary reason a polyelectrolyte films anticorrosion effect is the film's resistance to the diffusion of small ions (e.g., salt ions) through the film. Additional factors which may contribute to the excellent corrosion resistance include: the fact that films were free of salt ions within the bulk; the fact that the oppositely-charged polyelectrolyte segments are well matched yielding an “intrinsic” compensation of charge (see Schlenoff et al, J. Am. Chem. Soc., 1998, 120, 7626); and the fact that the water in the films is not “free” or in “pools” but is bound to polyelectrolyte ion pairs which results in the water having a low chemical activity. Additionally, the intimate, molecular contact of the film with the surface is believed to prevent the occlusion of pockets of electrolyte at the steel/coating interface. The first polymer layer is positively charged and adheres strongly to the negatively-charged native oxide layer on the surface of steel. Despite their gel-like properties, polyelectrolyte multilayer films adhere tenaciously to the underlying substrate, even at high liquid shear rates. See Farhat and Schlenoff, Langmuir, 2001, 17, 1184.

To determine what importance, if any, water in a polyelectrolyte multilayer has on corrosion resistance, a hydrophobic coating was deposited on abraded stainless steel wire for evaluation. The hydrophobic polyelectrolyte solutions were applied in the above-described manner using poly(N-octyl-4-vinyl pyridinium iodide)(PNO4VPI) in ethanol and poly(styrene sulfonate)(PSS) in methanol. The coatings comprised 40 alternating layers and had a thickness of about 70 nm. As seen in FIG. 1 the performance of the hydrophobic coating was nearly the same as the hydrophillic coating. Thus, the inclusion of water in the anticorrosion polyelectrolyte films of the present invention has little effect on corrosion resistance.

### EXAMPLE 2

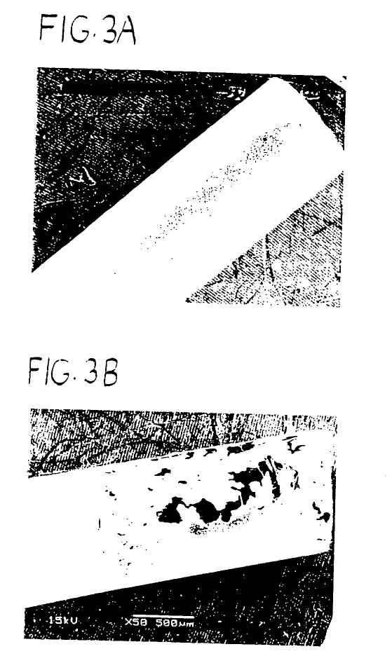

Coated and uncoated abraded stainless steel wires were also prepared to be examined using Scanning Electron Microscopy (JEOL 5900 digital SEM). Specifically, they were polished in a standard sequence using 3 micrometer, 0.1 micrometer Buehler Metadi diamond paste (water base), and 1 micron, 0.05 micron Buehler ALPHA micropolish. These wires were subjected to anodic polarization in a 0.1M NaCl solution at a polarization potential of 0.7 volts for 14 hrs on the bare wire and 21 hrs on the PSS/PDAD coated wire. The respective corrosion currents at this potential were approximately 0.3 μA cm⁻² and 4.2 A cm⁻². As indicated in FIG. 3, there is a stark contrast between coated and uncoated wires maintained at 0.7 volts for 14 hours.

The foregoing examples show that polyelectrolyte coatings provide excellent resistance to corrosion and have properties that are not available with traditional resin, polymer or paint-based anticorrosion coatings. For example, polyelectrolyte films tend to be compliant, or soft, which allow a coating to heal over microscopic defects and prevent the occasional pit from leading to progressive or catastrophic failure of the film (atomic force microscopy of polyelectrolyte multilayer surfaces has revealed the mobility of polymeric constituents, especially when salt is present. See Dubas and Schlenoff, “Swelling and Smoothing in Polyelectrolyte Multilayers”, Langmuir 2001, 17, 7725. In contrast, small defects in traditional coatings may rapidly lead to the deterioration of the coating/metal interface and lead to peeling or flaking of the coating. Given the desirability of healing over of microscopic defects, it would be advantageous to include one or more polymeric components with an enhanced mobility that accelerates healing of exposed areas. Such a polymer might have lower molecular weight, and/or lower charge density (number of charges per unit weight of the polymer) and/or enhanced mobility because of molecular structure. An example of a polyelectrolyte with lower molecular weight is poly(styrene sulfonate) with a molecular weight of about 10,000. An example of a polyelectrolyte having a lower charge density is a copolymer of PDAD (charged) and PAC (neutral). Such an enhanced ability to heal must be balanced against undesirable properties, such as enhanced ion permeability due to greater swelling of polyelectrolyte complex.

Polyelectrolyte multilayers are also desirable for surface coatings because of their ease of application. Specifically, not all charges need to be ion paired for rapid formation of a film via ionic bonds. Furthermore, there is little dependence of coating on molecular weight, polymer concentration and deposition time. See Dubas and Schlenoff, Macromolecules, 1999, 32, 8153. Unlike many methods for producing thin films, the self-limiting properties of the multilayering method produce very uniform, contour-following coatings. Also, defects encountered during film formation, such as dust particles, are occluded and then patched over.

In view of the above, it will be seen that the several objects of the invention are achieved and other advantageous results attained. It is intended that all matter contained in the above description shall be interpreted as illustrative and not in a limiting sense.

What is claimed is:

1. A corrosion resistant structure comprising:
a metallic substrate comprising a surface; and
an anticorrosion polymer coating deposited onto at least a portion of the metallic substrate surface, the anticorrosion polymer coating comprising a polyelectrolyte complex, the polyelectrolyte complex comprising a positively-charged polyelectrolyte and a negatively-charged polyelectrolyte.

2. The corrosion resistant structure of claim 1 wherein the positively-charged polyelectrolyte and the negatively-charge polyelectrolyte are selected from the group consisting of linear polyelectrolytes, branched polyelectrolytes, dendritic polyelectrolytes, graft polyelectrolytes and copolymers and block copolymers thereof.

3. The corrosion resistant structure of claim 1 wherein the positively-charged polyelectrolyte comprises a quaternary ammonium group.

4. The corrosion resistant structure of claim 3 wherein the positively-charged polyelectrolyte is selected from the group consisting of poly(diallyldimethylammonium chloride), poly(vinylbenzyltrimethylammonium), ionenes, poly(acryloxyethyltrimethyl ammonium chloride), poly(methacryloxy(2-hydroxy)propyltrimethyl ammonium chloride), protonated amines and copolymers thereof.

5. The corrosion resistant structure of claim 1 wherein the positively-charged polyelectrolyte comprises a pyridinium group.

6. The corrosion resistant structure of claim 5 wherein the positively-charged polyelectrolyte is selected from the group consisting of poly(N-methylvinylpyridine), other poly(N-alkylvinylpyridines), poly(N-octyl-4-vinyl pyridinium iodide), poly(N-octadecyl-2-ethynyl pyridinium bromide)(PNO2EPB), poly(N-alkyl-2-ethynyl pyridine), poly(N-alkl-4-ethynyl pyridine) and copolymers thereof.

7. The corrosion resistant structure of claim 1 wherein the negatively-charged polyelectrolyte comprises a sulfonate group.

8. The corrosion resistant structure of claim 7 wherein the negatively-charged polyelectrolyte is selected from the group consisting of poly(styrene sulfonate), poly(2-acrylamido-2-methyl-1-propane sulfonate), sulfonated poly(ether ether ketone), sulfonated lignin, poly(ethylenesulfonate), poly(methacryloxyethylsulfonate), sulfonated styrene block copolymers, their salts, and copolymers thereof.

9. The corrosion resistant structure of claim 1 wherein the negatively-charged polyelectrolyte is poly(acrylic acid).

10. The corrosion resistant structure of claim 1 wherein the anticorrosion coating comprises metallic oxide particles.

11. The corrosion resistant structure of claim 10 wherein the metallic oxide particles are selected from the group consisting of silicon dioxide, aluminum oxide, titanium dioxide, iron oxide, zirconium oxide and mixtures thereof.

12. A method for preparing a corrosion resistant structure, the method comprising:
a. providing a metallic substrate comprising a surface; and
b. depositing onto at least a portion of the metallic substrate surface an anticorrosion polymer coating, the anticorrosion polymer coating comprising a polyelectrolyte complex, the polyelectrolyte complex comprising a positively-charged polyelectrolyte and a negatively-charged polyelectrolyte.

13. The method as set forth in claim 12 wherein depositing the anticorrosion polymer coating comprises:
i. applying a first solution comprising a first polyelectrolyte onto the portion of the surface of the metallic substrate whereby the polyelectrolyte in the first solution is adsorbed onto the portion of the metallic substrate surface to form a first polymer layer comprising the first polyelectrolyte;
ii. applying a second solution comprising a second polyelectrolyte that is oppositely-charged from the first polyelectrolyte whereby the second polyelectrolyte is adsorbed onto the first polymer layer to form a second polymer layer comprising the second polyelectrolyte; and
iii. performing steps i and ii until the desired number of first and second polymer layers are formed.

14. The method as set forth in claim 13 comprising rinsing each first and second polymer layer with a rinsing liquid prior to applying the next first or second solution, the rinsing liquid being free of polyelectrolyte and comprising a solvent for the polyelectrolyte in the layer being rinsed.

15. The method as set forth in claim 14 wherein the polyelectrolyte rinsed from each layer is reintroduced into the solution from which it came.

16. The method as set forth in claim 14 comprising drying each rinsed layer prior to applying the next layer.

17. The method as set forth in claim 14 wherein the first and second solutions comprise about 0.01% to about 40% by weight of the first and second polyelectrolytes, respectively.

18. The method as set forth in claim 14 wherein the first and second solutions comprise about 0.1% to about 10% by weight of the first and second polyelectrolytes, respectively.

19. The method as set forth in claim 13 wherein the first polyelectrolyte and the second polyelectrolyte is a positively-charged polyelectrolyte comprising an ammonium group, a pyridinium group or a protonated amine, or a negatively-charged polyelectrolyte comprising a sulfonate group, acrylic acid or a deprotonated carboxylate.

20. The method as set forth in claim 19 wherein the negatively-charged polyelectrolyte comprising a sulfonate group is selected from the group consisting of poly(styrenesulfonic acid), poly(2-acrylamido-2-methyl-1-propane sulfonic acid), sulfonated poly (ether ether ketone), sulfonated styrene block copolymers, sulfonated lignin, poly(ethylenesulfonic acid), poly(methacryloxyethylsulfonic acid), their salts, and copolymers thereof; the negatively-charged polyelectrolyte comprising acrylic acid is selected from the group consisting of polyacrylic acid and polymethacrylic acid; the positively-charged polyelectrolyte comprising an ammonium group is selected from the group consisting of poly(diallyldimethylammonium chloride), poly(vinylbenzyltrimethylammonium), ionenes, poly(acryloxyethyltrimethyl ammonium chloride), poly(methacryloxy(2-hydroxy)propyltrimethyl ammonium chloride) and copolymers thereof; the positively-charged polyelectrolyte comprising a pyridinium group is selected from the group consisting of poly(N-methylvinylpyridine), other poly(N-alkylvinylpyridines), poly(N-octyl-4-vinyl pyridinium iodide, poly(N-octadecyl-2-ethynyl pyridinium bromide) and copolymers thereof; and the positively-charged polyelectrolyte comprising a protonated amine is poly(allylaminehydrochloride).

21. The method as set forth in claim 13 wherein the first and second solutions comprise an additive selected from the group consisting of an inorganic material, a medicinal material, a surface active ion and mixtures thereof, the inorganic material being selected from the group consisting of a metallic oxide, a clay mineral, a metal colloid, semiconductor nanoparticles and mixtures thereof, the medicinal material being selected from the group consisting of an antibiotic, an antiviral, an antifungal, a coagulant, a steroid, a biocompatibilizer, a sterilizer, an anticoagulant and mixtures thereof, and the surface active ion being selected from the group consisting of stearic acid, sodium stearate, sodium dodecyl sulfate, a quaternary alkyl ammonium and mixtures thereof.

22. The method as set forth in claim 13 wherein the first solution comprises metallic oxide particles selected from the group consisting of silicon dioxide, aluminum oxide, iron oxide, titanium dioxide, zirconium oxide and mixtures thereof.

23. The method as set forth in claim 13 wherein the second solution comprises metallic oxide particles selected from the group consisting of silicon dioxide, aluminum oxide, iron oxide, titanium dioxide, zirconium oxide and mixtures thereof.

24. The method as set forth in claim 13 wherein the first and the second solutions are applied by spraying.

25. The method as set forth in claim 13 wherein the first and the second solutions are applied by dip coating.

26. The method as set forth in claim 12 wherein depositing the anticorrosion polymer coating comprises:
i. providing a first solution comprising a positively-charged polyelectrolyte;
ii. providing a second solution comprising a negatively-charged polyelectrolyte;
iii. mixing the first and second solutions to form a polyelectrolyte complex precipitate;
iv. dissolving the polyelectrolyte complex precipitate in a solvent to form a polyelectrolyte complex solution or suspending the polyelectrolyte complex precipitate within a liquid to form a polyelectrolyte complex dispersion; and
v. applying the polyelectrolyte complex solution or the polyelectrolyte complex dispersion onto the portion of the metallic substrate surface whereby the polyelectrolyte complex in the polyelectrolyte complex solution or the polyelectrolyte dispersion is adsorbed onto the portion of the metallic substrate surface to form a polymer layer comprising the polyelectrolyte complex.

27. The method as set forth in claim 26 wherein the first solution comprises metallic oxide particles selected from the group consisting of silicon dioxide, aluminum oxide, iron oxide, titanium dioxide, zirconium oxide and mixtures thereof.

28. The method as set forth in claim 26 wherein the second solution comprises metallic oxide particles selected from the group consisting of silicon dioxide, aluminum oxide, iron oxide, titanium dioxide, zirconium oxide and mixtures thereof.
